(19) United States
(12) Patent Application Publication
(10) Pub. No.: US 2008/0267092 A1
(43) Pub. Date: Oct. 30, 2008

(54) Method and Apparatus for Maintaining Continuous Connections for Audio/Visual Communications

(76) Inventors: James F. Willenborg, San Francisco, CA (US); Ravin Suri, Oakton, VA (US); Scott M. Ober, Oakton, VA (US); Stephen J. Schmitt, Mears, MI (US); Andrew Wolf, New York, NY (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/739,645

(22) Filed: Apr. 24, 2007

(51) Int. Cl. H04L 12/16

(52) U.S. Cl. 370/259; 370/432

(57) ABSTRACT

A method and apparatus is provided for maintaining a continuous connection for the instantaneous transmission of audio/visual content between end points on a packet-based network. After a communication link is initially established between two end points connected to the network, the communication link is maintained on a continuous basis so that audio/visual content can be instantaneously transmitted from a source end point to a destination end point or end points when a user desires to communicate with the destination end point. The communication link is continuously maintained by various methods including across the packet-based network by transmitting signaling information between the end points that signifies that the communication link should be kept open and alive.

### TECHNICAL FIELD

This disclosure relates generally to the field of audio and video communications over packet-switched networks and, more particularly, to providing instant audio and video communication capabilities between two end points over a packet-switched network.

### BACKGROUND

Telephone communications generally utilize either circuit-switched networks or packet-switched networks (or a combination of both networks) to establish a communication link between two phones. Circuit-switched networks operate by establishing a dedicated connection or circuit between two points, such as that employed by the public switched telephone network (PSTN). A telephone call causes a circuit to be established from the originating phone through the local switching office across trunk lines, to a remote switching office and finally to the intended destination telephone. While such circuit is in place, the call is provided a dedicated data path for the voice signals between the two phones. Packet-switched networks typically establish an asynchronous “virtual” channel between two points. In a packet-switched network, data, such as a digitized voice signal, is divided into packets that are multiplexed over high capacity connections for transmission to a destination. Network hardware delivers packets to specific destinations where the packets are reassembled into the original data set. Packet-switched networks, such as the Internet, are used in establishing communications between two computers or other devices that employ Voice over Internet Protocol (VoIP) communications.

VoIP involves the transmission of voice data over IP networks. Two common protocols currently used for VoIP transmissions are H.323 and Session Initiation Protocol (SIP). H.323 is an ITU-T standard that was originally developed for video teleconferencing on IP networks and provides the technical requirements for voice communication over IP networks for both point to point communications and multipoint communications. SIP is an application-layer control that uses requests and responses to establish communication “sessions,” such as Internet telephone calls, multimedia distribution, and multimedia conferences, between two or more end points on a network.

One of the drawbacks associated with VoIP communications is that there are delays associated with call setup times in establishing a connection with a destination end point. For instance, the call setup time for a H.323 VoIP call can take significantly longer than the setup time for an average circuit-based PSTN call, since the H.323 protocol requires that a session first be established and only then are the features and capabilities of that session negotiated between the end points. In establishing a VoIP call using the SIP protocol, the user initiating a call typically sends a SIP request to a SIP server requesting the address of the intended destination, where the SIP server then returns the destination address to the caller for the caller to use in establishing a connection. A series of requests and responses and then exchanged between the caller and the destination end points to establish a communication connection.

Another challenge in setting up VoIP communications is determining the routing of VoIP traffic through firewalls and address translators to establish a communication path over the Internet between two end points. All of these setup procedures required by the various VoIP communication protocols to establish a communication link across a packet-based network such as the Internet can require significant delays that a caller must endure before being able to communicate with a destination party.

### SUMMARY

According to a feature of the disclosure, a method and apparatus is provided for maintaining a continuous connection for the instantaneous transmission of audio/visual content between end points on a packet-based network. The communication link or “line” between the end points is continuously connected or always “on.” The communication link is maintained on a continuous basis so that audio/visual content can be transmitted from a source end point to a destination end point on demand when a user desires to communicate with the destination end point without any noticeable delay caused by call setup times. The communication link is continuously maintained across the packet-based network by transmitting signaling information between the end points that signifies that the communication link should be kept open and alive.

The communication link needs only be initiated once between any two end points for all future transmissions, with the exception of if any devices in the communication path of the communication link go “off net” or are disconnected, such as the routing servers or the source or destination end points, upon which the communication link would need to reestablished for future communications. In one aspect, the establishment of the communication link is performed independent of any transmission. To the users at either end point, the communication link is always in a waiting state ready to transmit data to or receive data from the other end point so that the user may experience the instant transmission of voice, video or other data on demand when such user initiates a communication action.

In accordance with one feature, the present method and apparatus allow audio/visual content to be immediately transmitted between the end points over the continuous communication link when a content transmission is desired without suffering from call setup delays usually encountered when establishing a connection between two end points over a packet-based network. The audio/visual content is thus transmitted from the source end point to the destination end point with substantially no noticeable delay to the source end point.

In one aspect, it may appear to a user at one end point that the connection is “connecting” and “disconnecting” in terms of functionality but not in terms of delay. However, in what appears to the user as a “disconnected” state, a source end point may transmit information to keep the connection open and alive while making the end points function as though they are in a disconnected or “off” state. While in the “connected” state, the source end point may transmit voice, video or other types of audio/visual data across the communication link that has been kept open and alive.

### DRAWINGS

The above-mentioned features and objects of the present disclosure will become more apparent with reference to the following description taken in conjunction with the accompanying drawings wherein like reference numerals denote like elements and in which:

FIG. 1 is a block schematic diagram of one embodiment of a system for maintaining continuous connections for instant communications over a network in accordance with the present disclosure.

FIG. 2 is an operational flow diagram of a method for maintaining continuous connections for instant communications over a network in accordance with one embodiment of the present disclosure.

FIG. 3 is a block schematic diagram illustrating a continuous connection for instant communications over a network in accordance with one embodiment of the present disclosure.

FIG. 4 is a block schematic diagram illustrating multiple continuous connections for instant communications over a network in accordance with one embodiment of the present disclosure.

### DETAILED DESCRIPTION

In the following description, numerous embodiments are set forth in order to provide a thorough understanding of the invention. It will be apparent, however, to one skilled in the art, that these and other embodiments may be practiced without these specific details. In other instances, well-known features have not been described in detail in order not to obscure the invention.

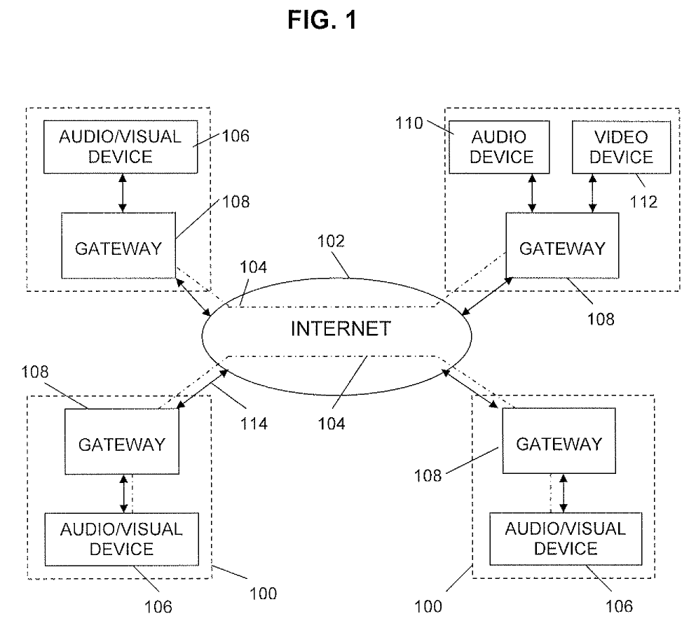

Referring now to FIG. 1, a block schematic illustration is provided of a system for maintaining a continuous connection for the transmission of content between at least two end points 100 across a packet-based network 102. The end points 100 are connected to the packet-based network 102, such as the Internet or another type of network connection capable of delivering IP packets, including but not limited to a local area network (LAN), wide area network (WAN) or other communication network. The end points 100 include a content source, such as audio/visual device 106, and a gateway 108 that connects the audio/visual device 106 to the network 102. The gateway 108 provides connectivity and access to the network 102 for the audio/visual device 106 and routes outgoing data across the network and incoming data to the audio/visual device 106. In one aspect, the gateway 108 may comprise a router or high speed Internet connection for communicating data packets across the network 102.

In one embodiment, the audio/visual device 106 may comprise any device capable of generating or outputting audio data, video data or other type of audio/visual data. In one aspect, the audio/visual device 106 may include a microphone for a user to input audio data to be sent to another end point 100 and a speaker for audio data received from another end point 100 to be output to a user. In one aspect, the audio/visual device 106 may include a VoIP device, similar to a SIP phone or to an ATA connected to an analog device, capable of operating according to VoIP communication protocols. In another embodiment, the audio/visual device 106 may include a video camera for recording visual information, such as video and/or images, to be sent to another end point 100 and a display for displaying visual information received from another end point 100. In one embodiment, multiple devices may be separately connected to the gateway 108, such as an audio device 110 and a video device 112. In yet another embodiment, the audio/visual device 106 may comprise, or may be connected to, a personal computer or other similar device capable of recording audio/visual content data input by a user to be sent to another endpoint as well as appropriate peripheral devices for outputting similar data received over the network 102 from another end point 100.

The connection 114 between the audio/visual device 106 and the gateway 108 be a wired connection, such as through a cable or other similar device that connects into a port on the gateway 108, or may be a wireless connection, such as a WLAN, WiFi, WAP, WiMAX, Bluetooth, CDMA, WCDMA, GSM, CDPD, PDC, PHS, TDMA, FLEX, satellite or other wireless connection.

In one embodiment, a continuous communication link 104 is established between any two end points 100 connected to the network 102, where the communication link 104 represents a communication path or “virtual circuit” extending through the network 100 between at least two end points 100. The communication link 104 is shown as a dashed line in FIG. 1. The communication link may utilize both wired and wireless transmissions or a combination of both. The communication link 104 is continuously maintained to be open and alive between the two endpoints 100 so as to enable content to be communicated between the endpoints 100 without any noticeable delay caused by call setup times.

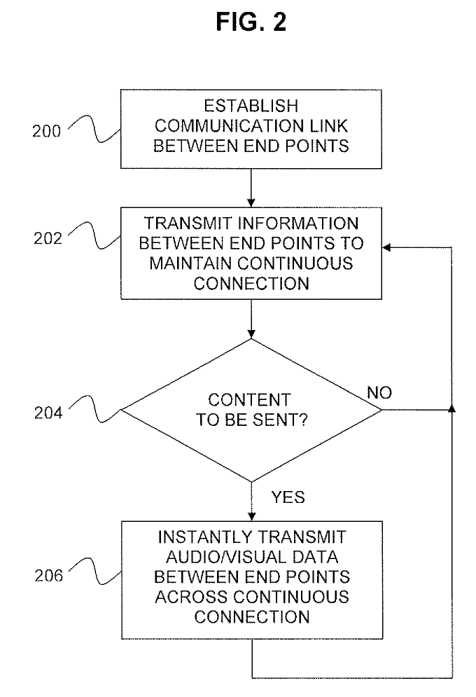

Referring now to FIG. 2, an operational flow diagram is illustrated of one embodiment of a method for maintaining a continuous connection for the transmission of content between two or more end points on a packet-based network. During initial installation or when a device at one of the end points 100 powers on, a communication link is set up in operation 200 between two end points connected to the network. In one aspect, the communication link may be established according to known VoIP communication protocols, while it is understood that other communication protocols can be utilized that establish a communication path over a network for the transmission of content. In operation 202, the communication link is maintained on a continuous basis so that a communication path is always available for the transmission of content between the end points. Maintaining a continuous communication link refers to keeping a communication path over the network 104 that is open and alive between two or more end points that does not require additional communication setup procedures in order to communicate content between the end points.

The communication link or “line” between the end points is continuously connected or always “on.” The communication link is maintained on a continuous basis so that audio/visual content can be instantaneously transmitted on demand from a source end point to a destination end point when a user desires to communicate with the destination end point. The terms “instant” or “instantaneously” as used herein in connection with describing the communications between the end points refers to communications that occur on demand by at least one of the end points with substantially no noticeable delay to the transmitting end point typically associated with call setup times. In one embodiment, the communication link is continuously maintained across the packet-based network by transmitting signaling information between the end points that signifies that the communication link should be kept open and alive. In one aspect, the communication link needs only be initiated once between any two end points for all future transmissions.

If any devices in the communication path of the communication link go “off net” or are disconnected, such as the routing servers or the source or destination end points, the communication link would need to reestablished for future communications. In one aspect, the establishment of the communication link is performed independent of any audio/visual content transmission. To the users at either end point, the communication link is always in a waiting state ready to communication data to the other end point so that the user may experience the instant transmission of voice, video or other audio/visual content when such user initiates a communication action.

Any number of possible mechanisms can be implemented to maintain the communication link 104 between the end points 100 open and alive. In one embodiment, the communication link is maintained by transmitting signaling information from one end point 100 to another end point 100, where the signaling information provides a notification to the receiving end point 100 that the communication link 104 should be maintained. In one aspect, after the communication link 104 is established between the end points 100, the communication can be placed in an idle state (e.g., “on hold”) with the end points 100 in a state ready to transmit and receive audio/visual content. Devices located at the end points 100 can also be respectively controlled to function according to such idle or hold state, such as by muting the microphone and speaker on both end points 100 of the communication link 104 while keeping all other variables the same as during real audio/visual communications. In this regard, any data such as “white noise” that is transmitted between the end points 100 would be disregarded and would not be processed and played over the speaker. In one aspect, whenever a user at one of the end points 100 wishes to communicate audio/visual content, the communication link 104 can be taken out of the idle or hold state to allow audio/visual communications to commence. For instance, an out-of-band packet can be sent to the receiving end point 100 to signify that communications are beginning so that the receiving end point 100 can take appropriate actions for receiving audio/visual content, such as un-muting the microphone and turning on the speaker.

In another aspect, in order to conserve bandwidth, the signaling information may comprise periodic or sporadic signals that are transmitted between the end points 100 at points in time required to keep the connection open and alive between the end points. For instance, the signaling information may include special data packets containing data that would contain signaling information instructing the end points 100 to keep the communication link 104 open and alive but would occupy a minimum or very low bandwidth across the communication link 104. In one aspect, the signaling information that is transmitted to maintain the communication link 104 continuously open and alive can be transmitted in packet form over the packet-based network 102, where the signaling information can further be sent in any format and can be provided at any location in the transmitted packet (e.g., in the flag, header, payload, etc.). In one embodiment, the signaling information can serve to not only instruct the destination end point 100 to maintain the communication link 104 open and alive but also can instruct intermediate components in the path of the communication link 104 across the network 102 to maintain the communication link 104 open and alive.

In one embodiment, the special data packets generated by one end point 100 may contain no audio/visual content but instead may contain a flag specifying that this particular special data packet should not be treated as containing audio/visual content. The end point 100 receiving such a special data packet would then discard the data contained in the special data packet and not perform any audio/visual functions with such data. In another embodiment, each end point 100 may include a normal codec for transmitting audio/visual content during communications and a very low bandwidth codec which transmits artificially generated white noise when the communication link 104 is merely being maintained. The receiving end point 100 recognizes which type of codec generated the data that is received, where data from the very low bandwidth codec is discarded. When user wishes to communicate with another end point 100, the originating end point 100 switches the codec to the actual, high-quality codec intended for actual communication, and the receiving end point 100 will recognize that content is being transmitted from the high-quality codec and will automatically decode packets and start playback accordingly.

In another embodiment, the communication link 104 can be maintained using any of the methods described herein or any other methods for only a limited period of time. After this limited period of time, the communication link 104 is terminated and then the communication link 104 is re-established and maintained for the limited period of time again. This process of establishing, terminating and re-establishing the communication link 104 is continuously repeated to maintain the communication link 104 open and alive for audio/visual content to be transmitted by an end point 100 on demand.

As described herein, the present system and method allow communications to occur between at least two end points 100 without suffering from call setup delays. The majority of the time consumed during call setup is detecting 1) presence information (i.e., is the other user online?), 2) location information (i.e., what is the other user's IP address?), 3) firewall penetration (i.e., what is the firewall/NAT topology at the end points?). In an alternative embodiment, all of the call setup information from a prior communication can be recorded and re-used to perform a communication on demand by one of the end points relying on the fact that none of the parameters have changed since the last successful communication. In this embodiment, call setup procedures can also be periodically performed to record the most desirable parameters.

By maintaining a continuous communication link 104 between the end points 100, content can be transmitted on demand without noticeable delay from a transmitting end point 100 to a destination end point 100 across the communication link 104 when the transmitting end point 100 is ready to send such content. Thus, in operation 204, a determination is made that content exists that one end point 100 desires to transmit to the destination end point 100. In operation 206, the content is instantly delivered from the transmitting end point 100 to a destination end point 100 with substantially no noticeable delay to the transmitting end point 100. The call setup delays that are conventionally associated with establishing a communication link between two end points are avoided by maintaining the continuous communication link 104, and content can be immediately delivered to the destination end point 100 across the continuous communication link 104 when a content transmission is desired without suffering such call setup delays. After the end points 100 have completed their content exchange, operation moves back to operation 202 where the communication link 104 is continuously maintained between the end points 100 during periods when no content is being exchanged across the communication link 104 between the end points 100.

In one aspect, it may appear to a user at one end point that the connection is “connecting” and “disconnecting” in terms of functionality but not in terms of delay. For instance, in what appears to the user as a “disconnected” state, a source end point may transmit “special packets” to maintain the communication link 104 open and alive while making the end points 100 function as though they are in a disconnected or “off” state (e.g., by muting or turning off their microphone and/or speaker), while in the “connected” state, the source end point may transmit voice, video or other types of audio/visual data across the communication link.

In one embodiment, the content may comprise audio/visual content that may be either audio data, video data, or a combination of audio data and visual data. In one aspect, the audio/visual data may include speech or voice data, where the voice data may be packetized at the end point 100 and transmitted according to Voice over Internet Protocol (VoIP) communication protocols or other protocols for transmitting packetized data over a packet-based network.

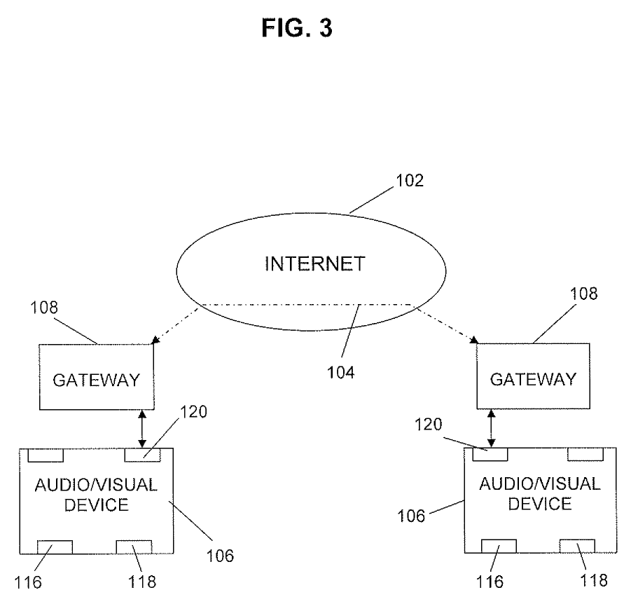

Referring now to FIG. 3, a block schematic illustration is provided for one embodiment of a VoIP system that allows for the instantaneous transmission of voice data between audio/visual devices 106 that are connected to the network 102. While this embodiment will be described as transmitting voice data, it is understood that other embodiments could transmit other types of audio data or video data through respective components. In one aspect, the audio/visual devices 106 may be VoIP devices having at least one of a microphone 116 and speaker 118 providing respective inputs/outputs for the transmission of voice data. A communication link 104 is established and continuously maintained between at least two VoIP devices 106, where the VoIP devices 106 are connected to the network 102 through respective gateways 108. In this manner, a voice communication channel is established over the communication link 104 and is always maintained open and alive by transmitting the requisite signaling information to the other VoIP device 106. For instance, in one embodiment, the minimum amount of data required to keep the connection alive can be exchanged between the VoIP devices 106, such as by exchanging “special packets” described above. The VoIP device 106 receiving the signaling information recognizes that such information is intended to keep the connection alive and therefore does not send such information to the speaker located in the VoIP device 106. Only actual voice content that is transmitted to the receiving VoIP device 106 is provided to the speaker 118 to be played to a user.

In one embodiment, each VoIP device 106 includes an activatable component 120 (e.g., a button, switch, mouse click activation of an icon in a computer program, sound-detection component, voice-activity-detection component, etc.) that can be activated by a user when that user wants to transmit voice data to another VoIP device 106 over the communication link 104. The connection over the communication link 104 is always available to transmit audio/visual data with substantially no noticeable delay whenever the user desires. As soon as the activatable component 120 is activated and the user starts speaking, the VoIP device 106 will begin sending actual audio (or video) packets to the destination VoIP device 106 without noticeable delay. The transmitted audio/visual content will be received substantially instantly by the destination VoIP device 106, since no call setup functions need to be performed between the source and destination VoIP devices 106. The destination VoIP device 106 will recognize that actual audio/visual content (i.e., voice data) is being received and will instantly begin outputting such audio/visual content to the user at the destination, such as by playing voice data over the speaker 118 or by displaying video data on a display.

In one embodiment, to speak with the destination VoIP device 106, a user at a source VoIP device 106 simply needs to activate the appropriate activatable component 120 and start talking. The VoIP devices 106 will then instantly set up either one way or two way communications between the VoIP devices 106, where the voice data from the source VoIP device 106 can be immediately played over the speaker 118 as it received at the destination VoIP device 106. In one embodiment, the VoIP device 106 receiving content can provide a notification to a user, such as an audible, visual or other notification that audio/visual content has been received and will be output. Alternatively, the user at the destination VoIP device 106 can be required to accept the received content before it will be output to the user. Still further, the user at the destination VoIP device 106 can place the destination VoIP device 106 in a quiet or private mode that prevents the received content from being output if the user does not want to be disturbed or is unavailable.

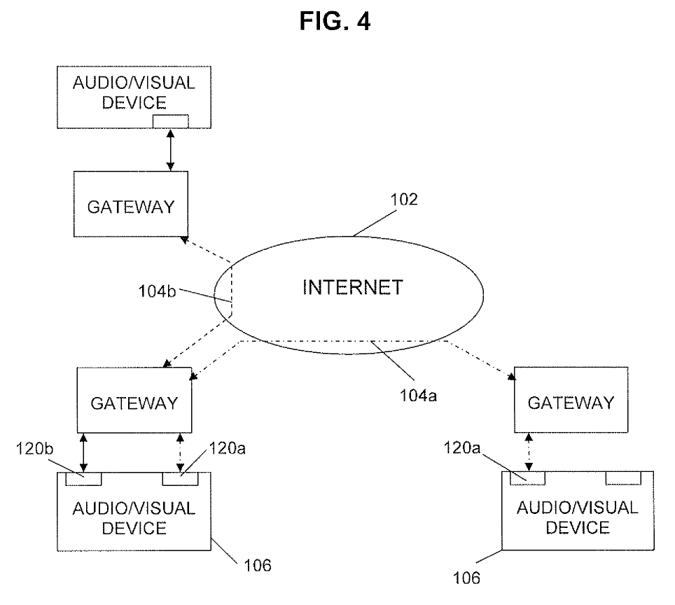

In one embodiment, each VoIP device 106 can be connected to a plurality of other VoIP devices 106 through a respectively number of communication links 104 (each communication link individually referred to as 104a, 104b, etc.), as illustrated in FIG. 4. The VoIP device 106 may include a respective number of activatable components 120a, 120b, . . . , 120n that may be activated for each of the communication links 104a, 104b, . . . , 104n, where n represents a discrete number of communication links that each VoIP device 106 may possess.

In one embodiment, the VoIP device 106 can be a simple device without a conventional keypad to dial numbers that only includes a finite number activatable components 120 that provide connectivity to respective number of other VoIP devices 106. In this manner, communications can only occur with the specific VoIP devices 106 that are associated with the continuously maintained communication links. The communication links 104 can be initially established between respective VoIP devices 106 and assigned to specific activatable components 120 on a VoIP device 106 using a centralized database or website. Users can log in to the website and assign their speed dial activatable components 120a, 120b to certain phone numbers, IP addresses or other identifying information (e.g., activatable component 120a is assigned phone number 555-555-5555, button 120b is assigned IP address 555.555.5.55, etc.). A central log-in server or servers may be configured to maintain the network address/locations of any VoIP device 106 connected to the network, as is customary and known in VoIP communication protocols. A presence or connection server can provide the address/location of the destination VoIP device 106 the user assigns to a certain activatable component 120, and a communication link 104 may then be set up between the two VoIP devices 106.

Again, while the embodiments described with reference to FIGS. 3 and 4 refer to the audio/visual devices 106 as VoIP devices for transmitting speech between the end points 100, it is understood that the audio/visual devices 106 could transmit other types of audio and video content through respective components.

In an alternative embodiment, rather than continuously maintaining the communication link 104 open and alive between two end points 100, the communication link 104 could be kept open by consistently re-opening or re-establishing the communication link 104 at a configurable, predetermined intervals so that the communication link 104 will be available for instantaneous transmission when a source end point 100 wants to transmit content to a destination end point 100.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method, comprising maintaining a continuous connection for the transmission of audio/visual content on demand between at least two end points on a packet-based network.

2. The method of claim 1, further comprising:
setting up at least one communication link between a plurality of end points connected to the network;
maintaining the communication link on a continuous basis for the transmission of content instantly on demand between end points.

3. The method of claim 1, wherein the content is selected from at least one of audio data and video data.

4. The method of claim 1, wherein the content is selected from at least one of voice, video, and other audio/visual data.

5. The method of claim 1, further comprising transmitting a data packet containing information to maintain the connection between the two or more end points.

6. The method of claim 2, wherein the content is speech data, the method further comprising establishing a Voice over Internet Protocol (VoIP) communication link.

7. The method of claim 1, further comprising maintaining the continuous communication link by transmitting signaling information between the end points that signifies that the communication link should be maintained.

8. The method of claim 7, wherein the signaling information comprises low bandwidth data packets transmitted between the end points.

9. The method of claim 7, wherein the continuous communication link is maintaining by disconnecting and reconnecting the communication link between the end points independently of the transmission on of content demand.

10. The method of claim 1, further comprising establishing a communication link across the Internet.

11. The method of claim 1, further comprising transmitting content between the end points over the continuous communication link with substantially no delay when a content transmission is desired.

12. The method of claim 13, further comprising transmitting content from a first of the two endpoints to a second of the end points with substantially no noticeable delay to the first end point.

13. The method of claim 2, further comprising a plurality of end points connected to the network, the method further comprising setting up and maintaining a plurality of established communication links between one of the end points and a plurality of other respective end points.

14. A method for enabling the instant transmission of audio/visual content between end points on a packet-based network, comprising:
maintaining an established communication link between two end points connected to the network on a continuous basis;
allowing audio/visual content to be transmitted on demand between the end points over the continuous communication link with substantially no delay.

15. The method of claim 14, wherein the audio/visual content is selected from at least one of audio data and video data.

16. The method of claim 15, wherein the content is speech data, the method further comprising establishing a Voice over Internet Protocol (VoIP) communication link.

17. The method of claim 14, further comprising maintaining the continuous communication link by transmitting signaling information between the end points that signifies that the communication link should be maintained.

18. The method of claim 14, further comprising establishing a communication link across the Internet.

19. The method of claim 14, further comprising a plurality of end points connected to the network, the method further comprising maintaining a plurality of established communication links between one of the end points and a plurality of other respective end points.

20. A system of maintaining a continuous connection for the transmission of content between two or more end points on a packet-based network, comprising:
a first audio/visual device located at a first end point connected to the network for sending and receiving audio/visual content;
a second audio/visual device located at a second end point connected to the network for sending and receiving audio/visual content;
a connection device for setting up a communication link over the network between the first and second end points and for maintaining the communication link on a continuous basis for the transmission of content on demand with substantially no delay between the first and second audio/visual devices.

21. The system of claim 20, wherein the audio/visual content is selected from at least one of audio data and video data.

22. The system of claim 21, wherein the audio/visual content is voice data, further wherein the connection device establishes a Voice over Internet Protocol (VoIP) communication link.

23. The system of claim 20, wherein the connection device maintains the continuous communication link by transmitting signaling information between the first and second end points that signifies that the communication link should be maintained.

24. The system of claim 20, wherein the connection device maintains the continuous communication link by transmitting low bandwidth data packets between the end points.

25. The system of claim 20, wherein the network is the Internet.

26. The system of claim 20, wherein the first and second audio/visual devices include transmission modules that allow content to be transmitted with substantially no delay between the first and second audio/visual devices over the continuous communication link when a content transmission is desired.

27. The system of claim 20, further comprising at least one additional audio/visual device connected to the network for sending and receiving audio/visual content; where the connection device establishes and maintains at least one additional communication link over the network between one of the first and second end points and the at least one additional audio/visual device a continuous basis for the transmission of content between one of the first and second audio/visual devices and the at least one additional audio/visual device.
